(19) United States
(12) Patent Application Publication
(10) Pub. No.: US 2004/0057395 A1
(43) Pub. Date: Mar. 25, 2004

(54) Channel recovery method and mobile communication system

(75) Inventor: Masaki Sakuma, Kanagawa (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/625,257

(22) Filed: Jul. 23, 2003

(30) Foreign Application Priority Data
Jul. 29, 2002 (JP) 220347/2002

(51) Int. Cl. H04B 7/185

(52) U.S. Cl. 370/318

(57) ABSTRACT

In a channel recovery method, it is monitored whether no synchronization is established for a predetermined period of time between a radio base station and a radio base station control station which constitute a mobile communication system. Channel re-synchronization is tried upon shifting the timing of a channel synchronization clock used for communication between the radio base station and the radio base station control station. A mobile communication system is also disclosed.

### BACKGROUND OF THE INVENTION

The present invention relates to a channel recovery method and, more particularly, to a channel recovery method for a case wherein a channel trouble occurs between a radio base station and a radio base station control station in a mobile communication system.

The arrangement of a conventional mobile communication system will be described with reference to FIG. 7.

In the mobile communication system, a plurality of radio base station control stations 2 are connected to one maintenance/monitoring console 1, and a plurality of radio base stations 3 are connected to each radio base station control station 2. A plurality of mobile units 4 are connected to each radio base station 3.

The maintenance/monitoring console 1 and the radio base station control stations 2 are connected to each other through wires. The radio base station control stations 2 and the radio base stations 3 are connected to each other through wires. The radio base stations 3 and the mobile units 4 are wirelessly connected to each other.

The radio base station control stations 2 and the radio base stations 3 are basically connected to each other through wires. However, in a place where a cable is difficult to lay, the radio base station control station 2 and the radio base station 3 are connected to each other through a simple radio apparatus installed between them.

A plurality of channels are connected per station between the radio base station control stations 2 and the radio base stations 3. The radio base station 3 is constituted by a plurality of cards having different functions.

As a synchronization scheme in the radio base station 3, a master-slave timing scheme of receiving clocks from the radio base station control station 2 or a simple radio apparatus is used.

For this reason, when a channel goes out of synchronization due to an instantaneous clock interruption or the like in the radio base station 3 which is receiving clocks from the simple radio apparatus, the radio base station 3 cannot establish channel synchronization with the radio base station control station 2 at the timing when the channel has lost synchronization. If, therefore, a channel trouble occurs, a maintenance person goes to the in-situ station and performs recovery operation.

The following problems are posed in this mobile communication system.

First, when channel synchronization cannot be established between a radio base station and a radio base station control station, it cannot be discriminated whether this is caused by a channel synchronization loss or the absence of clocks from the radio base station control station to the radio base station. This makes it necessary for the maintenance person to goes to the site.

Second, radio base stations are dispersed in various areas, and some installation place is difficult to visit, resulting in much time spent to perform recovery operation at the occurrence of a trouble.

In the above conventional mobile communication system, if channel synchronization cannot be established between a radio base station and a radio base station control station, the maintenance person must visit the radio base station.

In addition, the maintenance person cannot easily visit a radio base station depending on the installation place, it takes much time to perform recovery operation at the occurrence of a trouble.

### SUMMARY OF THE INVENTION

It is an object of the present invention to provide a mobile communication system which determines a channel synchronization loss, if a channel trouble caused between a radio base station and a radio base station control station is not recovered even after a lapse of a predetermined period of time, and tries channel re-synchronization control upon shifting the timing of a channel synchronization clock when the radio base station communicates with the remote radio base station control station so as to realize channel re-synchronization with the radio base station control station, thereby reducing the number of times a maintenance person visits the in-situ station.

In order to achieve the above object, according to the present invention, there is provided a channel recovery method comprising the steps of monitoring whether no synchronization is established for a predetermined period of time between a radio base station and a radio base station control station which constitute a mobile communication system, and trying channel re-synchronization upon shifting a timing of a channel synchronization clock used for communication between the radio base station and the radio base station control station.

### BRIEF DESCRIPTION OF THE DRAWINGS

FIG. 1 is a block diagram showing the arrangement of a mobile communication system according to the present invention;

FIG. 2 is a block diagram showing an embodiment of a radio base station to which a channel recovery method of the present invention is applied;

FIG. 3 is a flow chart for explaining a method of monitoring an operation state in a radio base station in FIG. 1;

FIG. 4 is a flow chart showing procedures for re-synchronization establishment processing and channel trouble notification processing in a radio base station in FIG. 1;

FIG. 5 is a flow chart showing system startup processing and the flow from detection of a channel disconnection to channel trouble notification in a radio base station in FIG. 1;

FIG. 6 is a flow chart showing procedures for updating operation parameters in a radio base station in FIG. 1; and

FIG. 7 is a block diagram showing the arrangement of a general mobile communication system.

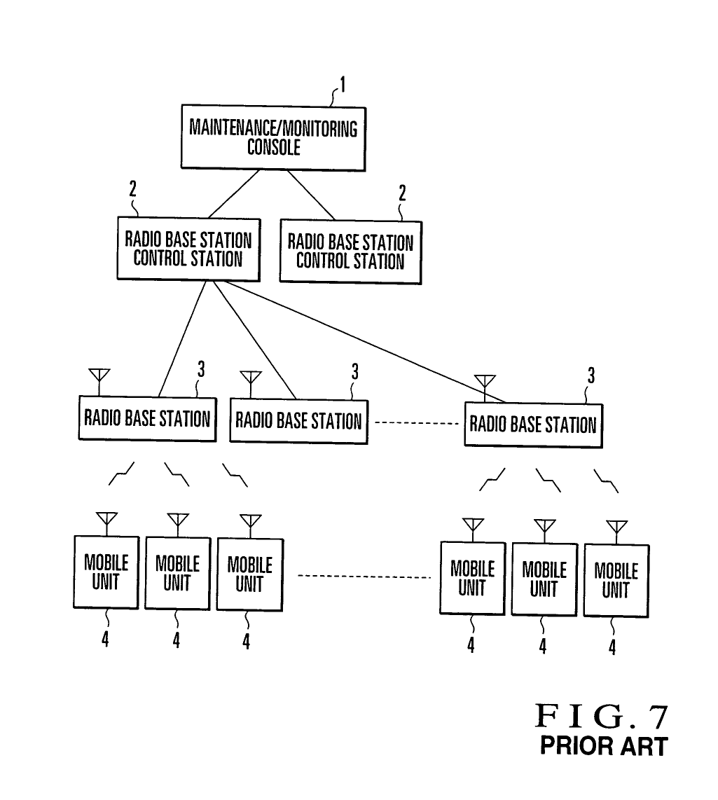

### DESCRIPTION OF THE PREFERRED EMBODIMENT

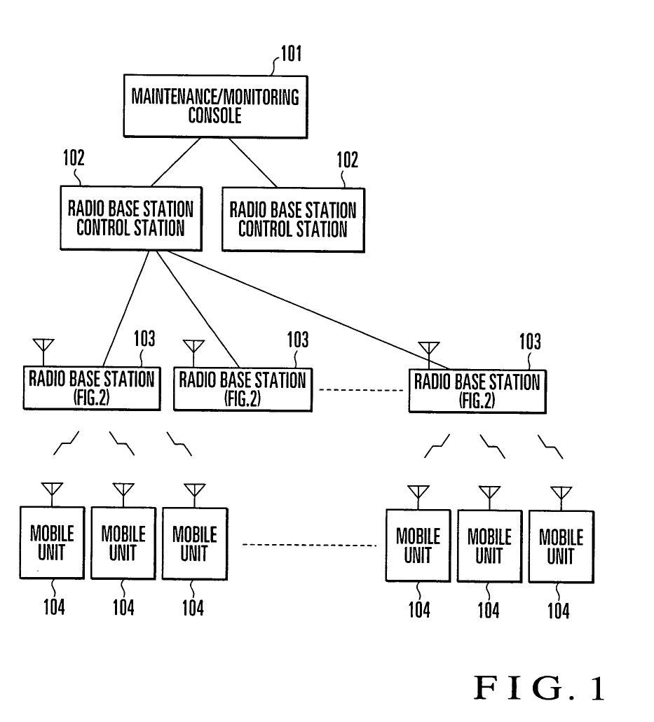

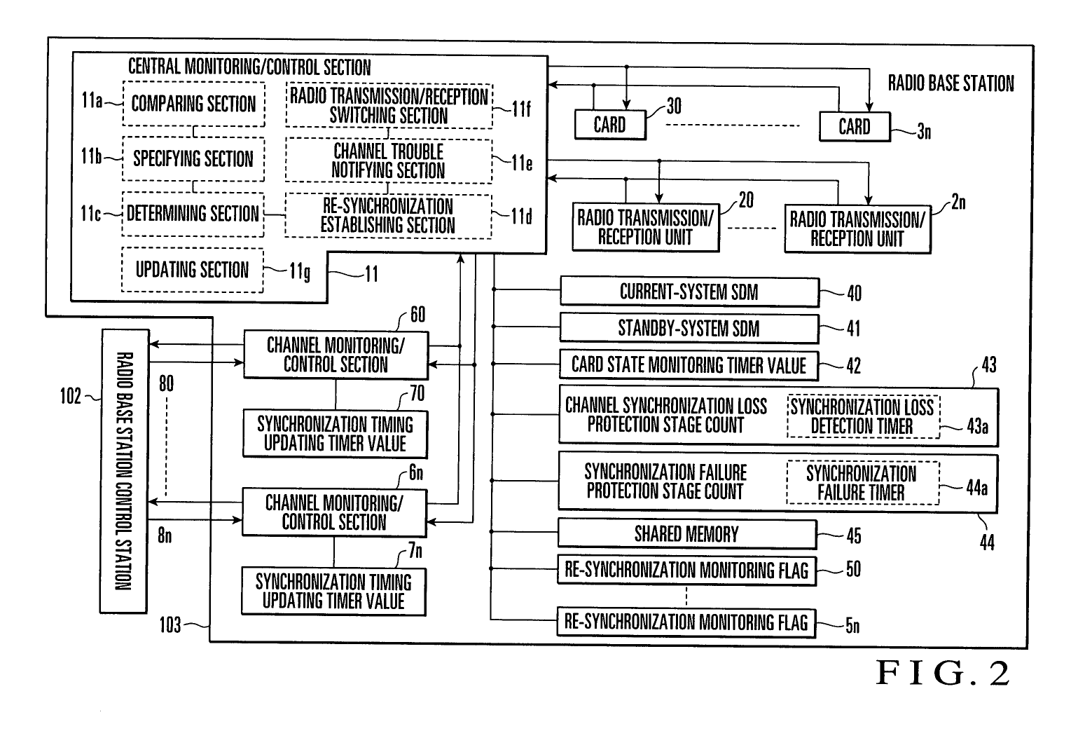

An embodiment of the present invention will be described next with reference to FIGS. 1 and 2.

A mobile communication system shown in FIG. 1 includes a maintenance/monitoring console 101 which monitors the overall operation information of the system, radio base station control stations 102 which are connected to the maintenance/monitoring console 101 and control a plurality of subordinate radio base stations 103, the plurality of radio base stations 103 connected to the radio base station control stations 102 through wires, and a plurality of mobile units 104 wirelessly connected to the radio base stations 103.

As shown in FIG. 2, the radio base station 103 includes a central monitoring/control section 11 which monitors and controls the overall operation of the radio base station 103, channel monitoring/control sections 60 to 6n which communicate with the radio base station control stations 102 serving as host stations through networks 80 to 8n, and radio transmission/reception units 20 to 2n which communicate with mobile units in radio zones.

The radio base station 103 also includes a plurality of cards 30 to 3n which constitute the radio base station 103 and have different functions, and a current-system SDM (Static Direct Memory) 40 and standby-system SDM 41 which constitute a redundant arrangement and store control programs for the operation of the radio base station 103 and operation parameters for monitoring an operation state between the radio base station 103 and the radio base station control station 102.

The radio base station 103 also includes a shared memory 45 for the expansion of operation parameters, a card state monitoring timer value 42 for monitoring the operation states of the cards 30 to 3n constituting the radio base station 103 in a predetermined cycle, and a channel synchronization loss protection stage count 43 for determining, when a channel disconnection has occurred, whether the channel disconnection has been caused by an instantaneous interruption or synchronization loss.

In addition, the radio base station 103 includes a synchronization failure protection stage count 44 for defining the maximum trial time for channel re-synchronization control, re-synchronization monitoring flags 50 to 5n for identifying a card subjected to a channel disconnection at the time of occurrence of a channel disconnection, and synchronization timing updating timer values 70 to 7n which are connected to the channel monitoring/control sections 60 to 6n and define a unit time for a trial of channel re-synchronization control at the time of occurrence of a channel synchronization loss.

The components connected to the central monitoring/control section 11 include the channel monitoring/control sections 60 to 6n, radio transmission/reception units 20 to 2n, cards 30 to 3n, current-system SDM 40, standby-system SDM 41, shared memory 45, card state monitoring timer value 42, channel synchronization loss protection stage count 43, synchronization failure protection stage count 44, re-synchronization monitoring flags 50 to 5n, and central monitoring/control section 11.

The central monitoring/control section 11 further includes a comparing section 11a, a specifying section 11b connected to the comparing section 11a, a determining section 11c connected to the specifying section 11b, a re-synchronization establishing section 11d connected to the determining section 11c, a channel trouble notifying section 11e connected to the re-synchronization establishing section 11d, and a radio transmission/reception switching section 11f connected to the channel trouble notifying section 11e. The central monitoring/control section 11 includes an updating section 11g.

The comparing section 11a monitors the operation state of each card. Upon detecting a state change, the comparing section 11a checks whether the detected contents are identical to those previously detected. If the detected contents differ from those previously detected, the comparing section 11a stores the contents. The specifying section 11b determines a card whose state change has been detected. The determining section 11c determines whether or not the contents of the state change correspond to a channel disconnection during the operation of the card.

The re-synchronization establishing section 11d prompts one of the channel monitoring/control sections 60 to 6n which has undergone a channel disconnection to perform channel re-synchronization, and checks a channel state. If a channel disconnection has occurred, the re-synchronization establishing section 11d registers a synchronization timing updating timer again.

The re-synchronization establishing section 11d also tries channel re-synchronization control upon shifting the timing of a channel synchronization clock in communicating with the radio base station control station 102. If a channel has been or is being established when the synchronization timing updating timer expires, the re-synchronization establishing section 11d cancels the operation of the synchronization failure timer upon reception of a channel re-synchronization establishment notification sent out from the channel monitoring/control section during channel establishment.

When channel re-synchronization establishment fails, the channel trouble notifying section 11e notifies the maintenance/monitoring console 101 of the corresponding information.

The radio transmission/reception switching section 11f stops one of the radio transmission/reception units 20 to 2n which is performing call connection using a troubled channel and switches to another radio communication means. If there is no normal channel, the radio transmission/reception switching section 11f restarts (resumes) the home station to prevent a call connection failure due to a channel trouble, and stands by until a channel with the radio base station control station 102 recovers.

The updating section 11g downloads operation parameters from the radio base station control station 102 and writes them in the standby-system SDM 41.

The channel synchronization loss protection stage count 43 includes a synchronization loss detection timer 43a for setting a time during which a state change is to be monitored. The synchronization failure protection stage count 44 includes a synchronization failure timer 44a for setting the maximum trial time for channel re-synchronization control upon shifting the timing of a channel synchronization clock.

Networks 81 to 8n can be connected for four channels at maximum between the radio base station 103 and the radio base station control station 102. If, for example, each of the networks 81 to 8n is constituted by a combination of a control channel and speech communication channel, two channels can be connected at the maximum.

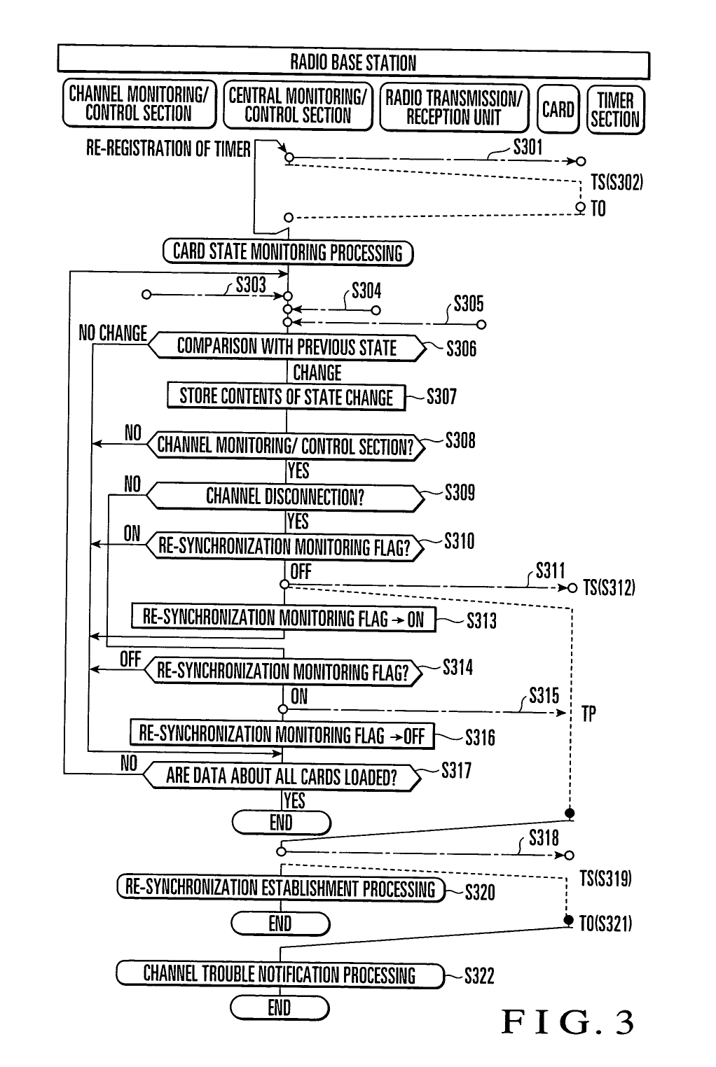

The operation of a radio base station based on a channel recovery method of the present invention will be described in detail next with reference to FIGS. 3 to 5.

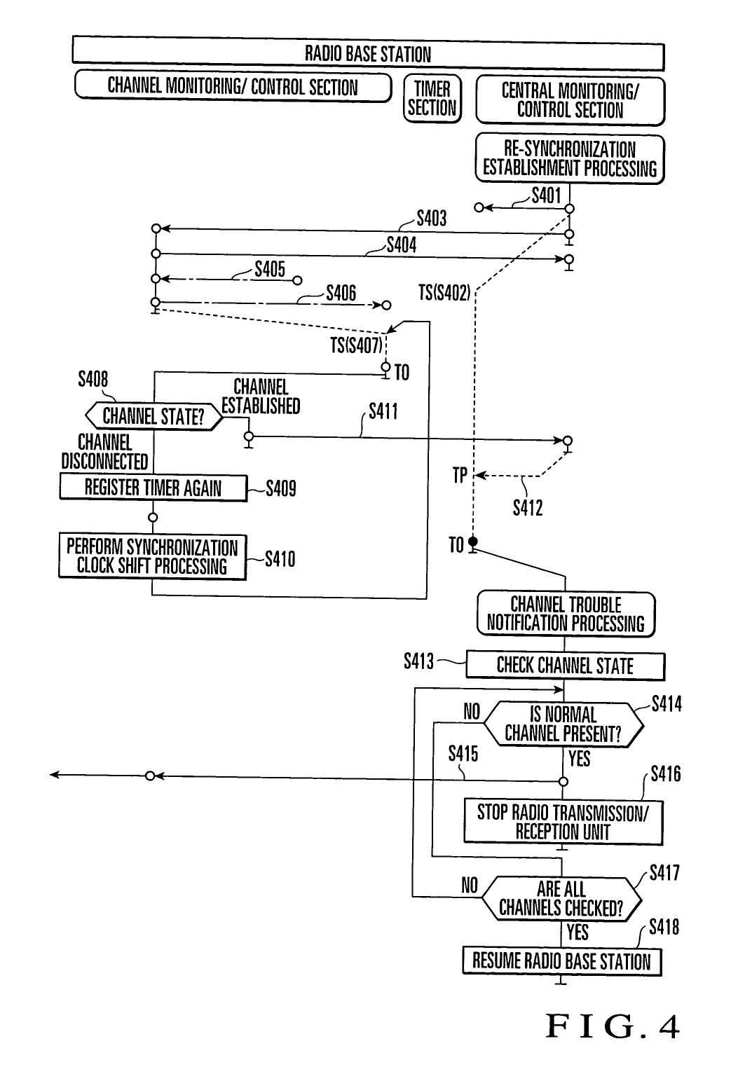

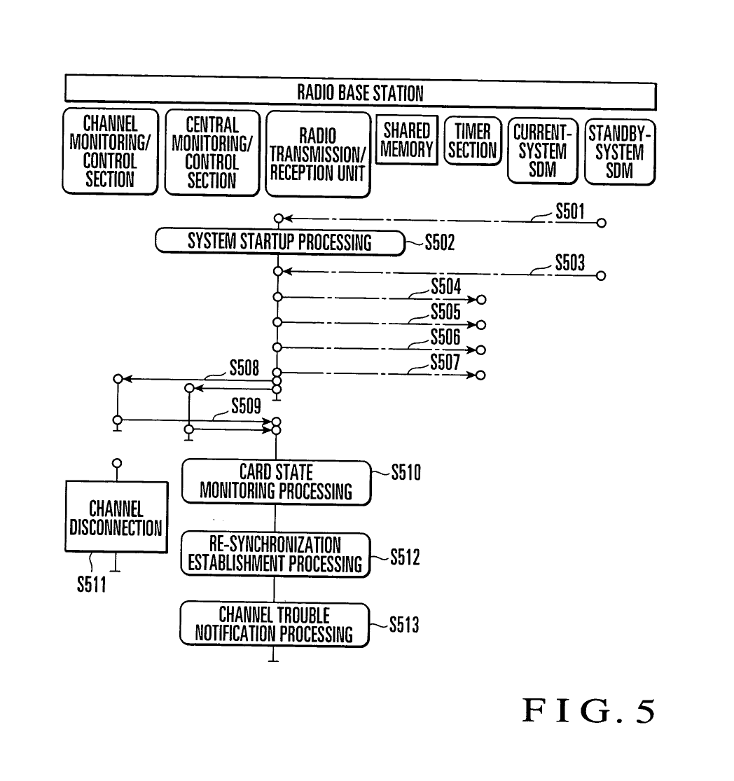

Of the steps to be described below, steps S301 to S322 will be described with reference to FIG. 3, steps S401 to S418 will be described with reference to FIG. 4, and steps S501 to S513 will be described with reference to FIG. 5.

(System Startup Processing)

In starting services by the system, control programs and operation parameters are externally written in advance in the current-system SDM 40 and standby-system SDM 41 in equal number.

The central monitoring/control section 11 loads the control programs written in the current-system SDM 40, and activates the channel monitoring/control sections 60 to 6n which communicate with the radio base station control station 102 through wires, the radio transmission/reception units 20 to 2n which performs signal transmission/reception in radio zones, and the cards 30 to 3n which constitute the radio base station 103 and have different functions, thereby starting operation (steps S501 and S502, steps S601 and S602, and steps S629 and S630).

Upon completion of the startup of the radio base station 103, the central monitoring/control section 11 reads out operation parameters for re-synchronization establishment from the current-system SDM 40, and expands the card state monitoring timer value 42, channel synchronization loss protection stage count 43, synchronization failure protection stage count 44, and synchronization timing updating timer values 70 to 7n in the shared memory 45 (steps S503 to S507, steps S603 to S607, and steps S631 to S635).

Upon expanding the operation parameters in the shared memory 45, the central monitoring/control section 0.11 transmits re-synchronization establishment parameters to the channel monitoring/control sections 60 to 6n and receive the corresponding responses (steps S508 and S509, steps S608 and S609, and steps S636 and S637).

(Card State Monitoring Processing)

The central monitoring/control section 11 reads out the card state monitoring timer value 42 expanded in the shared memory and registers it in a timer section 46 in order to monitor the operation state of each of the cards 30 to 3n constituting the radio base station 103 (steps S301 and S302).

When the timer in which the card state monitoring timer value 42 is registered expires, the central monitoring/control section 11 loads the operation state of each of the cards 30 to 3n constituting the radio base station 103 (steps S303 to S305).

The comparing section 11a of the central monitoring/control section 11 compares the operation state of each of the cards 30 to 3n having different functions with the corresponding previous state. If there is no change, the comparing section 11a checks the next card. Upon detecting a state change, the comparing section 11a checks whether the detected contents are identical to those previously detected.

If it is determined upon comparison that the contents are identical, the comparing section 11a of the central monitoring/control section 11 checks the next card. If the contents differ from each other, the corresponding contents are stored (steps S306 and S307).

After the contents of the state change are stored, the specifying section 11b of the central monitoring/control section 11 determines a specific card having a specific function from which the state change has been detected. If a trouble has occurred in one of the channel monitoring/control sections 60 to 6n, the determining section 11c of the central monitoring/control section 11 determines whether or not the trouble corresponds to a channel disconnection during the operation of the card (steps S308 and S309).

If the trouble corresponds to a channel disconnection, the corresponding one of the re-synchronization monitoring flags 50 to 5n respectively held in the channel monitoring/control sections 60 to 6n is checked (step S310). If the corresponding re-synchronization monitoring flag is OFF, it is checked whether the channel disconnection has been caused by an instantaneous interruption or synchronization loss.

The channel synchronization loss detection timer value is read out from the channel synchronization loss protection stage count 43 and registered in the timer section 46, and the corresponding re-synchronization monitoring flag is turned on (steps S311 to S313).

If the corresponding re-synchronization monitoring flag is ON, the operation state of the next card is checked (step S317).

If it is determined in step S309 that no channel disconnection has occurred, the corresponding re-synchronization monitoring flag is checked.

If the corresponding re-synchronization monitoring flag is ON, it is determined that the state change corresponds to a recovery from a channel disconnection. The re-synchronization monitoring flag is then turned off and the channel synchronization loss detection timer is stopped (steps S314 to S316). If the corresponding re-synchronization monitoring flag is OFF, the operation state of the next card is checked (step S317).

According to the above description, when the operation state of one of the channel monitoring/control sections 60 to 6n has changed, which has been caused by a channel disconnection during the operation of the card, and the corresponding re-synchronization monitoring flag is OFF, it is checked whether a channel disconnection is an instantaneous interruption.

A channel synchronization loss detection timer value is therefore read out and registered in the timer section 46. When the operation state of the channel monitoring/control section with the same card changes and the corresponding re-synchronization monitoring flag is OFF, it is determined that the change corresponds to a recovery from a channel disconnection, and the corresponding channel synchronization loss detection timer is interrupted (canceled).

This channel synchronization loss detection timer value is set to a time during which steps S303 to S317 are executed a predetermined number of times. If a recovery from a channel disconnection cannot be made within the time set in the timer, the timer is stopped, and control is passed to the procedure for channel re-synchronization establishment (steps S320 and S513).

When a channel disconnection occurs during the operation of a card, the channel synchronization loss detection timer is started, and the operation state of each card is monitored a plural number of times until the expiration of the timer, thereby determining whether or not a recovery is made, i.e., an instantaneous interruption or channel synchronization loss.

(Re-Synchronization Establishment Processing)

When the registered channel synchronization loss detection timer expires, a synchronization failure timer value is read out from the synchronization failure protection stage count 44 and registered in the timer section 46 (steps S318 and S319 and steps S401 and S402).

The synchronization failure timer value is used, in the event of a channel re-synchronization failure, as a standard for the timing of transmission of a channel trouble notification to the maintenance/monitoring console 101 for the sake of prompting it to check the channel for which channel re-synchronization cannot be established owing to a channel trouble. Alternatively, this value is used as the maximum trial time for channel re-synchronization control.

After the channel re-synchronization failure timer is registered, the re-synchronization establishing section 11d of the central monitoring/control section 11 sends out a re-synchronization establishment request to a channel monitoring/control section 6k (k=1 to n) subjected to the channel disconnection (step S403).

Upon reception of the re-synchronization establishment request, the channel monitoring/control section 6k reads out a synchronization timing updating timer value 6k of the re-synchronization establishment parameters received from the central monitoring/control section 11, and registers it in the timer section 46 (steps S404 to S407).

When the synchronization timing updating timer expires, the channel monitoring/control section 6k checks a channel state with a network 8k (step S408).

If a channel disconnection state is determined, the channel monitoring/control section 6k registers a synchronization timing updating timer again, and tries channel re-synchronization control upon shifting the timing of a channel synchronization clock in communicating with the radio base station control station 102 (steps S409 and S410).

When the synchronization timing updating timer expires, the channel monitoring/control section 6k checks the channel state with the network 8k.

If it is determined that a channel has been or is being established, the channel monitoring/control section 6k sends out a channel re-synchronization establishment notification to the central monitoring/control section 11. Upon reception of the channel re-synchronization establishment notification, the central monitoring/control section 11 stops (cancels) the synchronization failure timer (steps S411 and S412).

If the registered synchronization failure timer expires without channel synchronization establishment (step S321), the central monitoring/control section 11 checks the states of the networks 80 to 8n between the radio base station 103 and the radio base station control station 102 (step S413).

If the presence of a normal channel is determined, the channel trouble notifying section 11e of the central monitoring/control section 11 transmits a channel trouble notification to the maintenance/monitoring console 101 through the corresponding channel to prompt the maintenance/monitoring console 101 to make a channel check. In addition, the central monitoring/control section 11 stops a radio transmission/reception unit which is performing call connection using a troubled channel (steps S414 to S416).

If no available channel is present in the networks 80 to 8n with the radio base station control station 102, the radio base station 103 is resumed and set in the standby state until a channel with the radio base station control station 102 is recovered in order to prevent a call connection failure due to a channel trouble (step S418).

As described above, in this embodiment, after the central monitoring/control section 11 which monitors/controls the radio base station 103 starts the radio base station 103, the operation states of the cards 30 to 3n are monitored at intervals of a card state monitoring timer value.

If a channel trouble is detected in one of the channel monitoring/control sections 60 to 6n, the re-synchronization monitoring flag held in the channel monitoring/control section in which the trouble has been detected is turned on to monitor a state change within the time of a channel synchronization loss detection timer value.

If the trouble is recovered afterward, the corresponding re-synchronization monitoring flag is turned off again, and the channel synchronization loss detection timer is interrupted.

If the channel synchronization loss detection timer expires while the corresponding re-synchronization monitoring flag is kept on, i.e., the channel trouble is not recovered, the channel monitoring/control section corresponding to the channel trouble is caused to start re-synchronization control upon shifting the timing of a channel synchronization clock.

If the synchronization failure timer expires without channel establishment, the channel trouble notifying section 11e of the central monitoring/control section 11 transmits a channel trouble notification to the maintenance/monitoring console 101.

The radio transmission/reception switching section 11f of the central monitoring/control section 11 stops one of the radio transmission/reception units 20 to 2n which is performing call connection by using the troubled channel, and switches the mobile unit to another normal radio transmission/reception unit.

The above operation makes it possible to decrease the number of times the maintenance/monitoring console 101 is notified of the occurrence of a trouble and recovery in the event of a trouble due to a channel disconnection. Of the resources of the maintenance/monitoring console 101, therefore, the capacity used for the notification of troubles can be saved and assigned to another use.

(Updating of Operation Parameters)

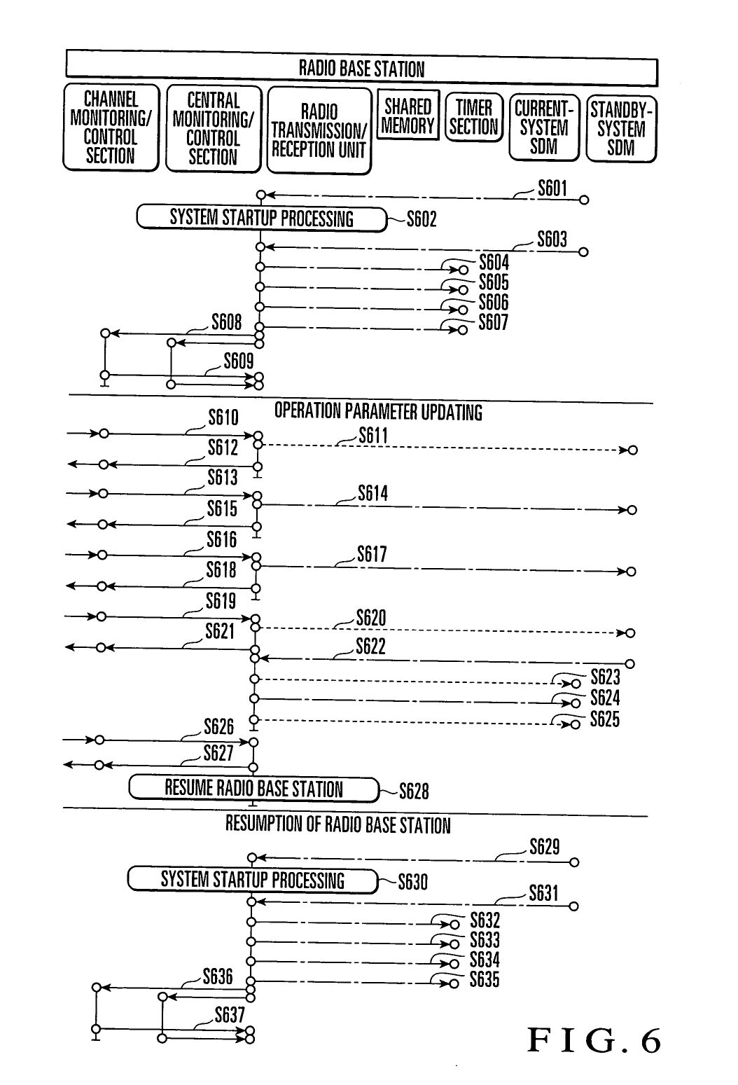

A case wherein the operation parameters which are being used by the radio base station 103 are updated will be described next with reference to FIG. 6.

The maintenance person transmits a station data download start request signal from the radio base station control station 102 to the channel monitoring/control sections 60 to 6n through the networks 80 to 8n under the control of the maintenance/monitoring console 101.

Upon reception of the station data download start request signal through the channel monitoring/control sections 60 to 6n, the updating section 11g of the central monitoring/control section 11 sets the standby-system SDM 41 in a write enable state, and returns a station data download start response signal (steps S610 to S612). The updating section 11g then receives the station data download request signal transmitted from the radio base station control station 102, and writes the contents of the signal in the standby-system SDM 41. After this write operation is complete, the updating section 11g transmits a station data download response signal to the radio base station control station 102 (steps S613 to S618).

Upon reception of a station data download end request signal from the radio base station control station 102, the updating section 11g of the central monitoring/control section 11 restores the standby-system SDM 41 to a write disable state, and returns a station data download end response signal to the radio base station control station 102 (steps S619 to S621).

Upon transmission of the station data download end response signal, the updating section 11g reads out the update operation parameter written in the standby-system SDM 41, and writes the parameter in the current-system SDM 40 after setting the current-system SDM 40 in a write enable state.

After the write operation, the updating section 11g restores the current-system SDM 40 to a write disable state, thus making the contents of the current-system SDM 40 and standby-system SDM 41 identical (steps S622 to S625).

When the maintenance person instructs the radio base station 103 to update the operation parameter at a proper update timing, the radio base station control station 102 transmits an operation parameter update request signal to the radio base station 103 in accordance with the operation parameter update request from the maintenance person (step S626).

Upon reception of the operation parameter update request signal, the radio base station 103 returns an operation parameter update request response to the radio base station control station 102, and resumes the radio base station 103, thus completing the operation parameter updating operation (steps S627 to S637).

As has been described above, according to the channel recovery method and mobile communication system of the present invention, if a synchronization is not established between a radio base station and a remote radio base station control station for a predetermined period of time, the radio base station tries channel re-synchronization control upon shifting the timing of a channel synchronization clock in communicating with the remote radio base station control station. This makes it possible to obtain the following effects.

First, when the radio base station periodically monitors each card, and a channel trouble occurs, the station determines whether the trouble is caused by an instantaneous interruption or channel synchronization loss. If it is determined that the trouble is caused by a channel synchronization loss, the channel connection failure can be quickly solved.

Second, when a temporary trouble such as an instantaneous interruption occurs or a channel is established by a re-synchronization trial, the maintenance/monitoring console is notified of nothing. This makes it possible to easily specify a radio base station in which a channel trouble has occurred.

What is claimed is:

1. A channel recovery method comprising the steps of:
monitoring whether no synchronization is established for a predetermined period of time between a radio base station and a radio base station control station which constitute a mobile communication system; and
trying channel re-synchronization upon shifting a timing of a channel synchronization clock used for communication between the radio base station and the radio base station control station.

2. A method according to claim 1, wherein
the step of monitoring comprises the steps of:
detecting a state change by monitoring, in a predetermined cycle, operation states of a plurality of cards constituting the radio base station and having different functions;
determining whether or not contents of a state change correspond to a channel disconnection of an operational channel; and
starting a channel synchronization loss detection timer in which a time during which a state change is monitored is set, thereby determining whether or not a channel synchronization loss has occurred, and
the step of trying the channel re-synchronization comprises the steps of:
trying channel re-synchronization when it is determined that a channel synchronization loss has occurred, and
when a channel re-synchronization trial fails, notifying a maintenance/monitoring console of the failure.

3. A method according to claim 2, wherein the step of detecting comprises the steps of
periodically starting a card state monitoring timer which defines a cycle in which an operation state is monitored,
monitoring an operation state of each card when the timer expires,
when a state change is detected, checking whether detected contents are identical to those previously detected, and
storing the contents when the detected contents differ from those previously detected.

4. A method according to claim 2, wherein the step of determining whether or not a disconnection of the operational channel has occurred comprises the steps of
specifying a card whose state change is detected as a card having a specific function, and
determining whether or not contents of the state change correspond to a channel disconnection during operation of the card.

5. A method according to claim 2, wherein in the step of determining whether or not the channel synchronization loss has occurred, if contents of the state change correspond to a channel disconnection during operation of card, a channel synchronization loss detection timer is started, and a re-synchronization monitoring flag for identifying a card having undergone a channel disconnection is turned on to detect a change in state of the same card within a timer time in a channel synchronization loss detection timer; it is determined that the channel disconnection is temporary, and operation of the channel synchronization loss detection timer is canceled if it is determined that the contents of the state change correspond to a recovery from a channel disconnection and the re-synchronization monitoring flag is ON; and a channel synchronization loss is determined if a change in state of the same card cannot be detected within the timer time in the channel synchronization loss detection timer.

6. A method according to claim 2, wherein the step of trying comprises the steps of
if a channel synchronization loss is determined, starting a synchronization failure timer and a synchronization timing updating timer, the synchronization failure timer defining at least one of a standard for a transmission timing of a channel trouble notification and a maximum trial time for channel re-synchronization, and the synchronization timing updating timer defining a unit time for a channel re-synchronization trial, and
checking a state of the channel upon expiration of the synchronization timing updating timer, and registering a synchronization timing updating timer again if a channel disconnection state is detected, while trying channel re-synchronization, and canceling operation of the synchronization failure timer if a channel has been or is being established when the synchronization timing updating timer expires.

7. A method according to claim 2, wherein the step of notifying comprises the step of, when the synchronization failure timer expires without establishing channel re-synchronization after a plural number of times of channel re-synchronization trials and there is a normal channel, transmitting a channel trouble notification to a maintenance/monitoring console to prompt the console to make a channel check by using the channel, stopping a radio transmission/reception unit which is performing call connection using the channel having undergone a channel trouble, and switching to another normal radio transmission/reception unit, the synchronization failure timer defining at least one of a standard for a transmission timing of a channel trouble notification and a maximum trial time for channel re-synchronization.

8. A method according to claim 2, wherein the step of notifying comprises the step of, if there is no normal channel, restarting (resuming) a home station and standing by until a channel with a radio base station control station is recovered, in order to prevent a call connection failure due to a channel trouble.

9. A mobile communication system including one maintenance/monitoring console, a plurality of radio base station control stations connected to said maintenance/monitoring console, a plurality of radio base stations connected to said radio base station control stations, and a plurality of mobile units which communicate with said radio base stations,
said radio base station including
channel synchronization loss determining means for determining a channel synchronization loss when no synchronization is established in a channel with one of said radio base station control stations which is connected to one of said radio base stations for a predetermined period of time,
re-synchronization control means for trying channel re-synchronization upon shifting a timing of a channel synchronization clock used for communication with said radio base station control station connected to said radio base station, and
notifying means for, when channel re-synchronization fails, notifying said maintenance/monitoring console of the failure.

10. A system according to claim 9, wherein
said radio base station further comprises
central control means for monitoring and controlling overall operation of the home station,
a plurality of radio communication means for performing signal transmission/reception in a radio zone,
a plurality of cards constituting the home station and having different functions,
a current-system SDM and a standby-system SDM which constitute a redundant arrangement and store a control program for operation of the home station and operation parameters for monitoring an operation state between the home station and said radio base station control station,
a shared memory in which a read operation parameter is expanded,
monitoring time setting means for monitoring operation states of said plurality of cards, in a predetermined cycle, of the operation parameters stored in said current-system SDM and said standby-system SDM,
synchronization establishing means for defining a maximum trial time for channel re-synchronization,
a monitoring flag for identifying a card having undergone a channel disconnection upon occurrence of a channel disconnection, and
synchronization timing setting means for defining a unit time for a channel re-synchronization trial upon occurrence of a channel synchronization loss, and
said re-synchronization control means comprises re-synchronization control means equal in number to channels and communicates with said radio base station control station through a network.

11. A system according to claim 10, wherein said central control means further comprises comparing means for periodically monitoring an operation state of each card at the expiration of a timer on the basis of said set monitoring time setting means, checking, upon detection of a state change, whether detected contents are identical to those previously detected, and storing the contents if the detected contents differ from those. previously detected.

12. A system according to claim 11, wherein said central control means further comprises
specifying means for determining one of said cards whose state change is detected, and
determining means for determining whether or not contents of the state change correspond to a channel disconnection during operation of said card.

13. A system according to claim 12, wherein
said synchronization loss determining means comprises a synchronization loss detection timer for setting a time during which a state change is monitored, and
said determining means starts a synchronization loss detection timer, if contents of the state change correspond to a channel disconnection during operation of said card, on the basis of said synchronization loss determining means, and turns on the monitoring flag to detect a change in state of said same card within a timer period of the synchronization loss detection timer; cancels operation of the synchronization loss detection timer, if it is determined that the contents of the state change correspond to a recovery from a channel disconnection and the monitoring flag is. ON; and determines a channel synchronization loss if no change in state of said same card is detected within a timer time in the synchronization loss detection timer.

14. A system according to claim 12, wherein
said synchronization establishing means comprises a synchronization establishment timer which sets a maximum trial time for channel re-synchronization control upon shifting a timing of a channel synchronization clock, and
said central control means further comprises re-synchronization establishing means for starting the synchronization establishment timer, if a channel synchronization loss is determined, on the basis of said synchronization establishing means, prompting said re-synchronization control means having undergone a channel disconnection to perform channel re-synchronization, causing said re-synchronization control means to set a synchronization timing value for said synchronization timing setting means, registering a synchronization timing updating timer if a channel disconnection state is determined upon checking of a channel state at the end of the synchronization timing, trying channel re-synchronization upon shifting a timing of a channel synchronization clock in communicating with said radio base station control station, and if a channel has been or is being established when the synchronization timing updating timer expires, canceling operation of the synchronization failure timer upon reception of a channel re-synchronization establishment notification sent out from said re-synchronization control means for which a channel is established.

15. A system according to claim 10, wherein
said notifying means transmits a channel trouble notification to a maintenance person to prompt the person to perform a channel check using a normal channel, if any, when the synchronization establishment timer of said synchronization establishing means expires without establishing any channel re-synchronization by a plural number of channel re-synchronization trials, and
said system further comprises switching means for stopping said radio communication means which is performing call connection using a channel having undergone a channel trouble, and switching to another radio communication means.

16. A system according to claim 15, wherein said switching means restarts (resumes) the home station and stands by until a channel with said radio base station control station is recovered, in order to prevent a call connection failure due to a channel trouble, if there is no normal channel.

17. A system according to clam 10, wherein said central control means further comprises updating means for downloading the operation parameter from said radio base station control station, writing the parameter in said standby-system SDM, and updating the parameter.
